(19) United States
(12) Patent Application Publication
(10) Pub. No.: US 2011/0248025 A1
(43) Pub. Date: Oct. 13, 2011

(54) ELECTROMAGNETIC INDUCTION HEATING DEVICE

(76) Inventor: Mario Dallazanna, Coquitlam (CA)

(21) Appl. No.: 13/085,953

(22) Filed: Apr. 13, 2011

Related U.S. Application Data
(60) Provisional application No. 61/323,837, filed on Apr. 13, 2010.

(51) Int. Cl. H05B 6/10

(52) U.S. Cl. 219/647

(57) ABSTRACT

An electromagnetic induction heating device comprises a pair of spaced-apart cores. Each of the cores has three arms with a coil wound about each of the arms. In each of the cores the coil wound about one of the arms is reverse wound compared to the coils wound about the other two arms. A controller controls the flow of current to the cores to generate magnetic fields at the arms of the cores. A workspace between the cores receives a workpiece to be heated. Preferably the cores are connected to a three phase alternating current supply.

### CROSS-REFERENCE TO RELATED APPLICATION

This application claims the benefit of provisional application No. 61/323,837 filed in the United States Patent and Trademark Office on Apr. 13, 2010, the full disclosure of which is incorporated herein by reference and priority to which is claimed.

### BACKGROUND OF THE INVENTION

1. Field of the Invention

The present invention relates to an electromagnetic induction heating device and, in particular, to an electromagnetic induction heating device for heating workpieces of varying shapes and sizes.

2. Description of the Related Art

It is known to heat workpieces using electromagnetic induction heating devices. For example, U.S. Pat. No. 7,315,011 issued to Alfredeen on Jan. 1, 2008 and the full disclosure of which is incorporated herein by reference, discloses a electromagnetic induction heating device including an energy feeding element, a control unit and at least two magnetic field generators. Each of the magnetic field generators has two free ends wherein all the free ends of the magnetic generators define a plane. The control unit is adapted to apply magnetic field energy to the magnetic field generators to generate alternating magnetic fields. The generated magnetic fields are such that the magnetic field through one of the free ends has an opposed direction as compared to the magnetic fields though the other free ends. In use a ferromagnetic workpiece being heated is positioned in a workspace disposed above the plane defined by the free ends of the magnetic field generators. The electromagnetic induction heating device disclosed by Alfredeen is therefore effective for heating flat workpieces but may be less efficient for shaped workpieces due to high dissipation of the magnetic field in the workspace.

To increase the concentration of the magnetic field some electromagnetic induction heating devices employ C-shaped magnetic cores with open ends positioned above and below a material to be heated. For example, U.S. Pat. No. 5,412,183 issued on May 2, 1995 to Buffenoir et al. and the full disclosure of which is incorporated herein by reference, discloses an electromagnetic induction heating device having two C-shaped cores which are spaced apart and angularly offset along an axial direction of advance of the workpiece being heated. The device disclosed by Buffenoir et al. is therefore effective for heating workpieces having a predetermined size and shape but may be less effective for heating smaller workpieces and workpieces which require a certain freedom of movement when inserted into and removed from a workspace. To address this concern various electromagnetic induction heating devices with folding and sliding magnetic cores have been developed. Examples include the electromagnetic induction heating devices disclosed in U.S. Pat. No. 4,708,325 issued on Nov. 24, 1987 to George, U.S. Pat. No. 4,828,227 issued on May 9, 1989 to Georges et al., and U.S. Pat. No. 5,373,144 issued on Dec. 13, 1994 to Thelander. The full disclosures of the aforementioned references are incorporated herein by reference.

However, electromagnetic induction heating devices with folding and sliding magnetic cores, while allowing freedom of movement of a workpiece in a workspace, may be limited to heating workpieces of a predetermined shape and size. The electromagnetic induction heating devices which allow both freedom of movement and the heating of workpieces of varying shapes and sizes must often do so by utilizing longer, less efficient and more mechanically complicated cores which are prone to increased noise generation. Such electromagnetic induction heating devices may also only allow for limited control over thermal profiles resulting in uneven heating of the workpiece. There accordingly remains a need for an improved electromagnetic induction heating device which allows the uniform heating of workpieces of varying shapes and sizes.

### SUMMARY OF THE INVENTION

It is an object of the present invention to provide an improved electromagnetic induction heating device.

It is another object of the present invention to provide an improved electromagnetic induction heating device which uniformly heats a workpiece throughout a heating cycle.

It is yet another object of the present invention to provide an improved electromagnetic induction heating device which allows freedom of movement of a workpiece in the workspace.

It is yet still another object of the present invention to provide an improved and more efficient electromagnetic induction heating device for heating conductive materials and, in particular, for heating ferrous and non-ferrous workpieces of varying shapes and sizes.

There is according provided a low frequency electromagnetic induction heating device powered by 50 or 60 hertz alternating current for use in industrial applications. The device is used to heat ferrous and non-ferrous metal workpieces to temperatures of up to 1200° Fahrenheit. The device is particularly suitable for effective heating of workpieces of varying shapes and sizes that may require homogeneous or controlled thermal profile. The device comprises a continuous one piece laminated silicon steel core in an E-shape having a 1, 2 and 3 coil configuration. Multiple cores may oppose each other in a vertical or horizontal plane or in a combination of vertical and horizontal planes including a 360° pattern. An alternating magnetic field induces an electric current flow in a conductive workpiece. The induced eddy currents generate thermal energy due to Joule Effect. The coils may be connected individually to a closed loop electrical system for temperature regulation. The current amplitudes and phases of the 3 leg electrical supply can be individually controlled to perform the desired thermal profile. The rate of temperature rise or decline can be adjusted. Set point temperature is maintained indefinitely or for a predefined period of time by means of controlled current flow through the coils.

There is more specifically provided an electromagnetic induction heating device for heating a workpiece. The electromagnetic induction heating device comprises a pair of spaced-apart cores. Each of the cores has three arms with a coil wound about each of the arms. The coil wound about one of the arms may be reverse wound compared to the coils wound about the other two arms. Alternatively, all of the coils may be wound in the same direction. A controller controls the flow of current to the cores to generate magnetic fields at the arms of the cores. A workspace between the cores receives the workpiece to be heated. Preferably the cores are connected to a three phase alternating electrical current supply.

There is still more specifically provided an electromagnetic induction heating device for heating a workpiece which comprises a pair of spaced apart E-shaped cores formed from a plurality of laminated metal sheets. Each of the cores has three arms with a coil wound about each of the arms. In each of the cores a middle one of the coils is reverse wound as compared to outer ones of the coils. Alternatively, all of the coils may be wound in the same direction. A plurality of switching current controllers is connected in series with each of the coils. This enables independent control of both amplitude and phase of a flow of current through each of the coils to generate a magnetic field at each of the arms of each of the cores. In each of the cores a direction of the magnetic field generated at one of the arms is opposite to a direction of the magnetic field generated at each of the other two arms. There is a workspace defined in a space between the cores. The workspace is for receiving the workpiece to be heated. Each of the arms of a first one of the cores may face a corresponding one of the arms of a second one of the cores. The coil on each of the arms of the first one of the cores may be reverse wound as compared to the coil on the corresponding one of the arms of the second one of the cores. The device may further include a transformer and a fuse electrically connected to each of the switching current controllers. This enables the switching current controllers to work synchronously with corresponding lines of a three-phase alternating current supply. Each of the cores may be connected to a three phase alternating current supply in three wire Delta configuration.

The electromagnetic induction heating device disclosed herein provides the advantages of uniformly heating the material throughout the heating cycle and reducing heating times which may reduce thermal stress.

The electromagnetic induction heating device disclosed herein also provide the advantage of improving temperature accuracy by allowing heating precision to within +/−1° Celsius.

The electromagnetic induction heating device disclosed herein further provides the advantage of efficient and balanced usage of industrial three-phase power lines.

The electromagnetic induction heating device disclosed herein may be used in applications, including but not limited to, die and mold preheating, aluminum extrusion, bending, forging, tempering, curing, stress relieving, demagnetization and bearing heating in the automotive, aviation, medical and metalworking industries.

### BRIEF DESCRIPTIONS OF DRAWINGS

The invention will be more readily understood from the following description of the embodiments thereof given, by way of example only, with reference to the accompanying drawings, in which:

FIG. 1 is a front elevation view of an improved electromagnetic induction heating device;

FIG. 2 is a partially schematic isometric view illustrating a pair of spaced-apart cores of the electromagnetic induction heating device of FIG. 1;

FIG. 3 is another partially schematic isometric view illustrating the spaced-apart cores of the electromagnetic induction heating device of FIG. 1 with a workpiece disposed in a workspace;

FIG. 4 is a circuit diagram of one of the cores of the FIGS. 2 and 3;

FIG. 5 is a graph illustrating a performance curve of the electromagnetic induction heating device of FIG. 1; and

FIGS. 6A, 6B and 6C are end views of one of the cores of FIGS. 2 and 3 illustrating momentary eddy current distribution at different moments of time in a workpiece subjected to a magnetic field of the electromagnetic induction heating device of FIG. 1.

### DESCRIPTIONS OF THE PREFERRED EMBODIMENTS

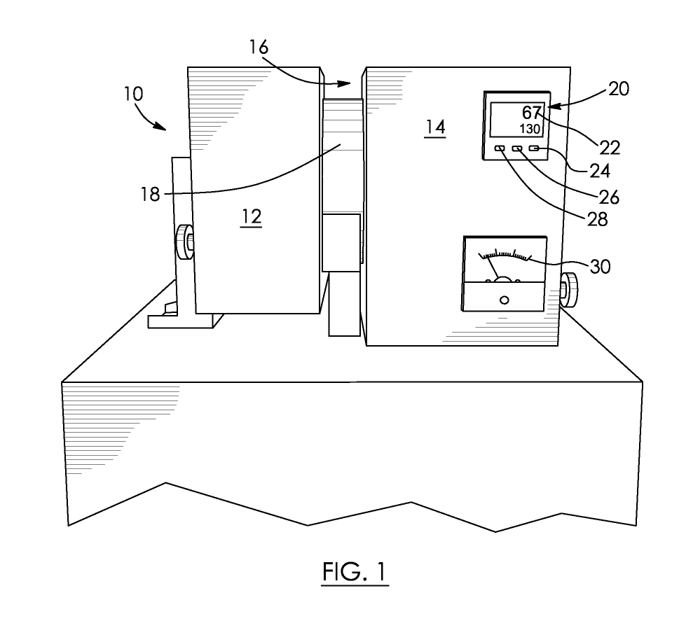

Referring to the drawings and first to FIG. 1, this shows an improved electromagnetic induction heating device 10. The electromagnetic induction heating device 10 includes a first housing portion 12 and a second housing portion 14. There is a space 16 between the first housing portion 12 and the second housing portion 14. The space 16 is for receiving a workpiece 18 being heated. There is a user interface 20 disposed on an exterior of the second housing portion 14. The user interface 20 includes a display 22, an LED display in this example, which may be used to display various parameters including, for example, temperature. The user interface 20 further includes a plurality of input means 24, 26 and 28. The input means, buttons in this example, may be used to power up the electromagnetic induction heating device 10 as well as to incrementally increase or decrease the output of the electromagnetic induction heating device 10. There is also a meter 30 disposed on the second housing portion 14. The meter 30 may be used to measure voltage, current or the overall power consumption and may be, for example, an ammeter or voltmeter.

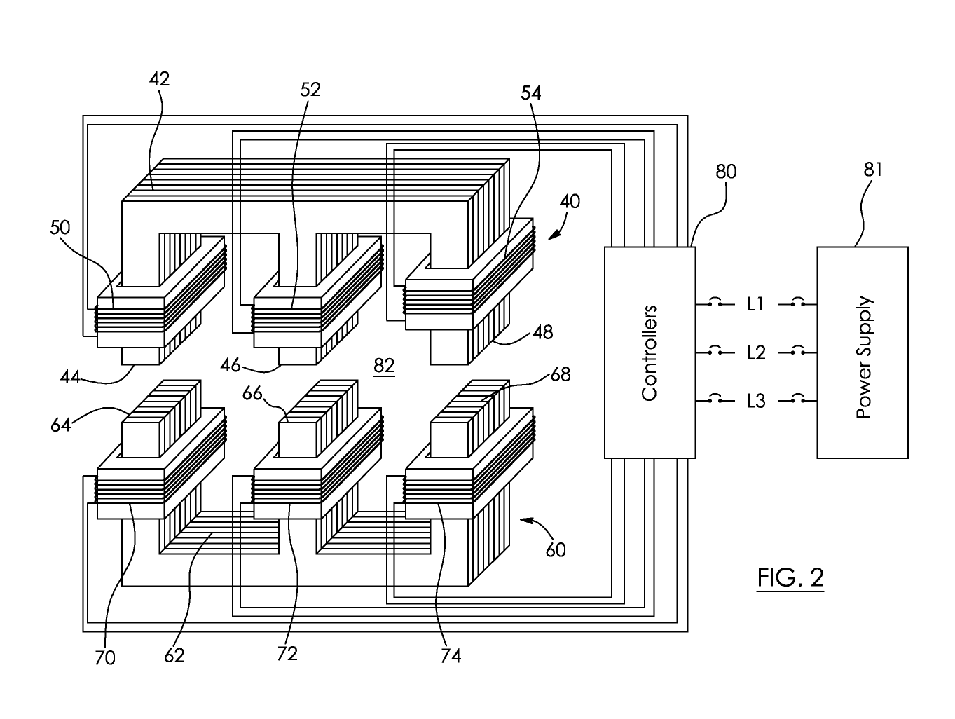

The housing portions 12 and 14 each house a corresponding one of a pair of spaced-apart cores 40 and 60 which are shown in FIG. 2. Each of the cores 40 and 60 is formed from a plurality of laminated metal sheets 42 and 62, respectively. A first one of the cores 40 is substantially E-shaped and has three arms 44, 46 and 48. Coils 50, 52 and 54 are wound about corresponding ones of the arms with one of the coils being wound in a reverse direction as compared to the other two coils. In this example, the coil 52 wound about a middle one of the arms 46 is reverse wound as compared to the other two coils 50 and 54. A second one of the cores 60 is also substantially E-shaped and has three arms 64, 66 and 68. Coils 70, 72 and 74 are wound about corresponding ones of the arms with one of the coils being wound in a reverse direction as compared to the other two coils. In this example, the coil 72 wound about a middle one of the arms 66 is reverse wound as compared to the other two coils 70 and 74.

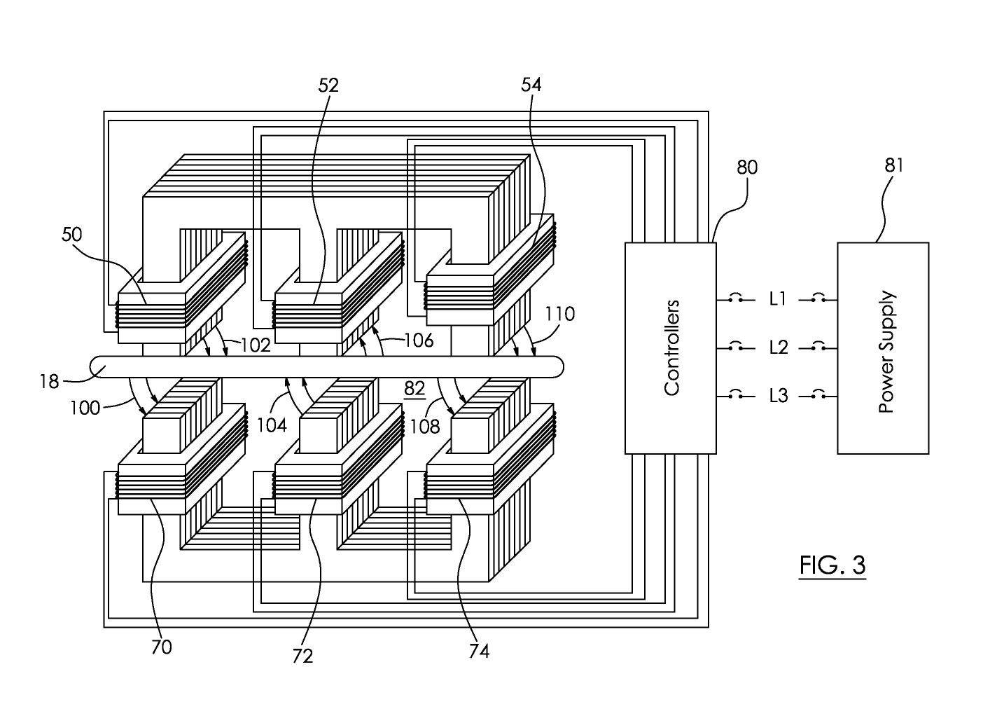

A controller 80 controls the flow of current to the cores 40 and 60, and thereby controls the generation of magnetic fields at the arms. A space 82 between the cores 40 and 60 generally corresponds to the space 16 between the first housing portion 12 and the second housing portion 14 which is shown in FIG. 1, i.e. the first core 40 is disposed in the first housing portion 12 and the second core 60 is disposed in the second housing portion 14. The workpiece 18 being heated is accordingly received in space 82 between the spaced-apart cores 40 and 60. FIG. 3 shows the workpiece 18 being received between the cores 40 and 60 during the heating process. The controller 80 controls the flow of current to the cores 40 and 60, and thereby controls the generation of magnetic fields at the arms. The amplitude and phase of the currents in each coil may be adjusted to obtain the best efficiency and thermal profile.

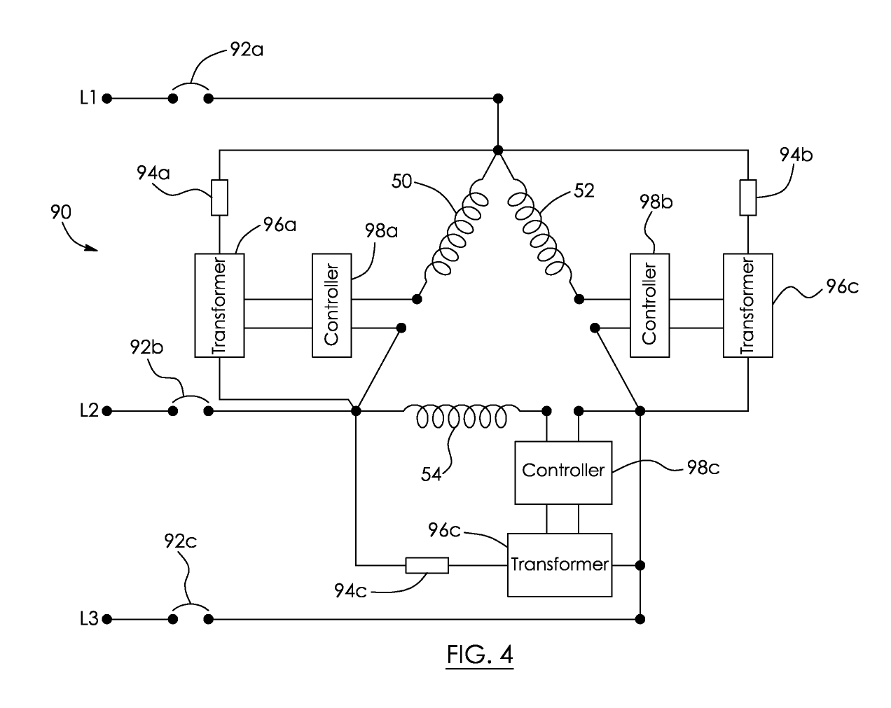

A circuit diagram of a three phase system of the first core 40 is shown in FIG. 4. The circuit 90 includes three conductors in the form of wires L1, L2 and L3 which are connected to a power source in the form of a three phase alternating current power supply. Each of the wires is provided with a corresponding switch 92a, 92b and 92c, respectively. There is a plurality of fuses 94a, 94b and 94c, a plurality of transformers 96a, 96 and 96c, and a plurality of switching current controllers 98a, 98b and 98c. In this example, the three phase system is a three wire Delta configuration. However, in other examples, the three phase system may be connected in a Y configuration or each coil 50, 52 and 54 may be connected individually and directly to a dedicated controller/power source. The wiring configuration may also further include a fourth neutral wire.

In the circuit diagram shown in FIG. 4 the switching current controllers 98a, 98b and 98c are connected in series with each of the coils 50, 52 and 54 enabling independent control of the average current running through each coil. The switching current controllers 98a, 98b and 98c are supplied from the corresponding lines of the three-phase power source by means of transformers 96a, 96b and 96c and fuses 94a, 94b and 94c. Such a configuration enables the switching current controllers to work synchronously with the corresponding lines of the three-phase power source. The circuit diagram of FIG. 4 will be readily understood by a person skilled in the art and is accordingly not described in further detail herein. It will further be understood by a person skilled in the art that the circuit diagram of a three phase system of the second core 60 is substantially similar to the circuit diagram of the three phase system of the first core 40 as shown in FIG. 4.

Referring back to FIGS. 2 and 3 opposed pairs of coils 50 and 70, 52 and 72, and 54 and 74 are typically wound or connected in a reverse direction to each other so that the opposing free ends of the cores 40 and 60 represent different magnetic poles at any time in case of zero current phase shift between the opposing cores. The magnetic field lines tend to go from one opposing free end towards the other as best shown by arrows 100, 102, 104, 106, 108 and 110 in FIG. 3. In multiple core embodiments of the device the adjacent cores are connected in reverse to each other to ensure maximum heating efficiency. For example, in FIG. 3, if coils 50, 72 and 54 generate a north pole then coils 70, 52 and 74 would generate a south pole.

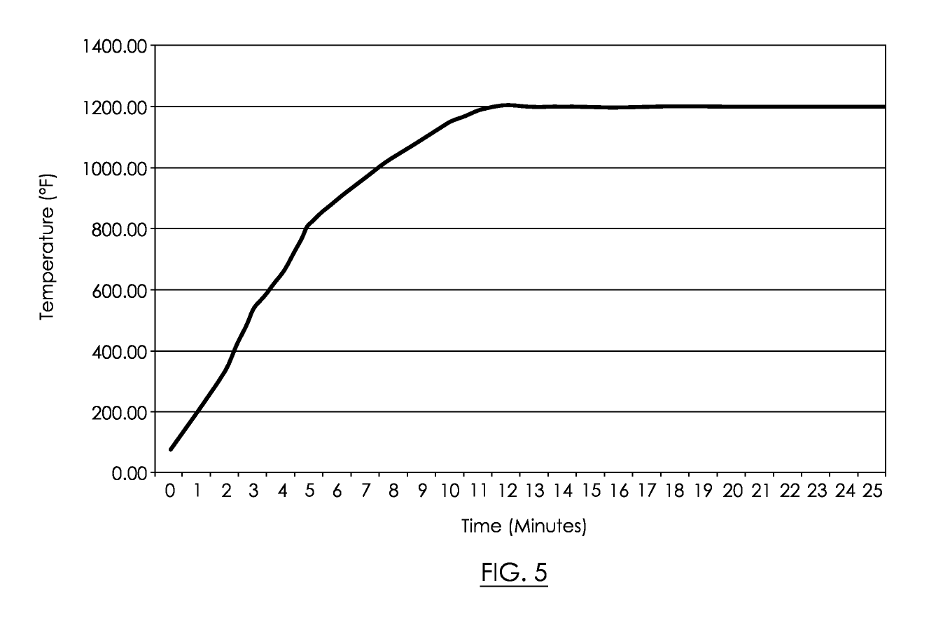

The magnetic fields at the free ends of the cores 40 and 60 spread into the workpiece 18 being heated perpendicular to a surface of the workpiece or under inclination or even longitudinally depending on the current phase angle at each moment of time. The workpiece 18 is evenly heated because the workpiece is received between the two spaced-apart cores 40 and 60. The current distribution in the workpiece changes following the momentary phase angle between the coils 50 and 70, 52 and 72, and 54 and 74 of each core. Using a three-phase system increases the efficiency of the electromagnetic induction heating device and uniformity of the workpiece heating. Temperatures of at least 1200° Fahrenheit (approximately 650° Celsius) may be achieved within ten minutes as shown in FIG. 5.

In the embodiment of the electromagnetic induction heating device 10 disclosed herein the coils 40 and 60 are supplied by a conventional three-phase power supply with a 120° phase shift between the coils 50 and 70, 52 and 72, and 54 and 74. The three-phase design has the advantage of balancing the load of the industrial power source and more importantly it provides the efficient and uniform induction heating. Current distribution will change in time due to changing phase angle relationships of the currents in the coils 50 and 70, 52 and 72, and 54 and 74.

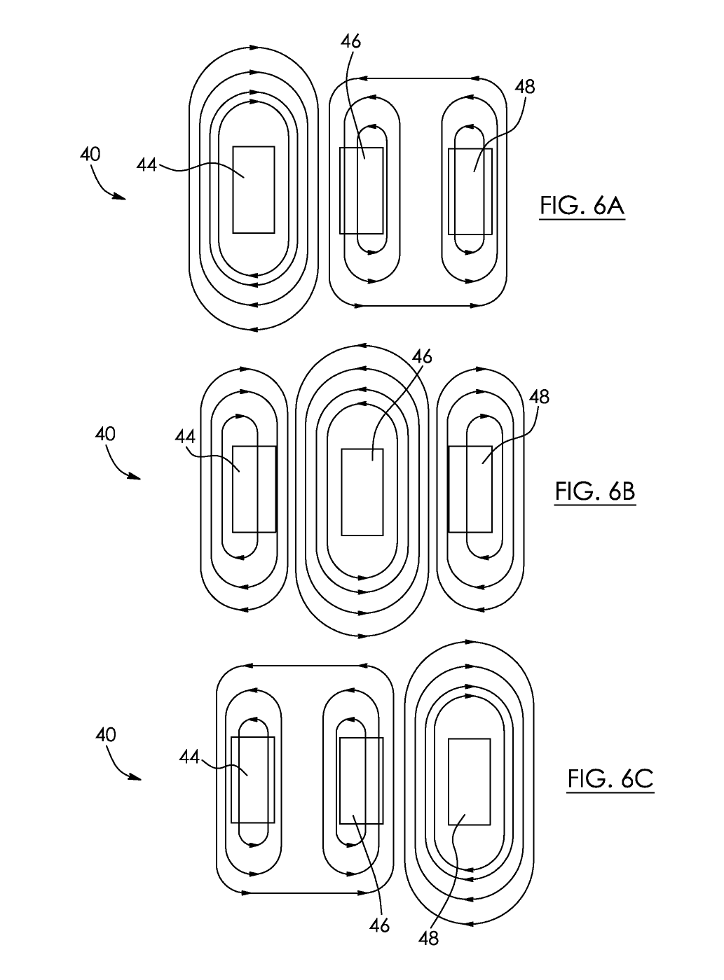

Examples of the momentary current distribution at different points in time are shown in FIGS. 6A, 6B and 6C for the first core 40. The periodically changing balance of magnetic flux between the coils effectively amounts to the appearance of a longitudinal magnetic field component. The longitudinal magnetic flux component is particularly profound when an additional phase shift is introduced between the two opposing cores. As a result of the periodically changing spatial current distribution, more efficient and uniform heating of the workpiece is achieved. The device is no longer a pure transverse flux induction heater. In fact it combines the advantages of both transverse and longitudinal flux approaches. In other embodiments of the electromagnetic induction heating device, additional control of the spatial current distribution may be achieved by means of individual current amplitude and phase control in each of the coils.

It will be understood by a person skilled in the art that many of the details provided above are by way of example only, and are not intended to limit the scope of the invention which is to be determined with reference to the following claims.

What is claimed is:

1. An electromagnetic induction heating device for heating a workpiece, the device comprising:
a pair of spaced apart cores, each of the cores having three arms with a coil wound about each of the arms, in each of the cores the coil wound about one of the arms being reverse wound compared to the coils wound about the other two arms;
a workspace defined in a space between the cores, the workspace being for receiving the workpiece to be heated; and
a controller for controlling a flow of current to the cores to generate a magnetic field at each of the arms of each of the cores, wherein in each of the cores a direction of the magnetic field generated at one of the arms is opposite to a direction of the magnetic field generated at each of the other two arms.

2. The device as claimed in claim 1 wherein the cores are formed from a plurality of laminated metal sheets.

3. The device as claimed in claim 1 wherein the cores are E-shaped.

4. The device as claimed in claim 1 wherein the controller controls both amplitude and phase of the flow of current to the cores.

5. The device as claimed in claim 1 wherein each of the cores is connected to a three phase alternating current supply.

6. The device as claimed in claim 1 wherein each of the cores is connected to a three phase alternating current supply in three wire Delta configuration.

7. The device as claimed in 1 wherein the controller includes a plurality of switching current controllers connected in series with each of the coils to enable independent control of the flow of current through each of the coils.

8. The device as claimed in claim 7 further including a transformer and a fuse electrically connected to each of the switching current controllers to enable the switching current controllers to work synchronously with corresponding lines of a three phase alternating current supply.

9. The electromagnetic induction heating device as claimed in claim 3 wherein in each of the cores a middle one of the coils is reverse wound as compared to outer ones of the coils.

10. The electromagnetic induction heating device as claimed in claim 1 wherein each of the arms of a first one of the cores faces a corresponding one of the arms of a second one of the cores, and the coil on each of the arms of the first one of the cores being reverse wound as compared to the coil on the corresponding one of the arms of the second one of the cores.

11. Use of the device as claimed in claim 1 in an application selected from the group of applications including die preheating, mold preheating, bearing heating, extrusion, bending, forging, tempering, curing, stress relieving and demagnetization.

12. An electromagnetic induction heating device for heating a workpiece, the device comprising:
a pair of spaced apart E-shaped cores formed from a plurality of laminated metal sheets, each of the cores having three arms and a coil wound about each of the arms, in each of the cores a middle one of the coils being reverse wound as compared to outer ones of the coils;
a workspace defined in a space between the cores, the workspace being for receiving the workpiece to be heated; and
a plurality of switching current controllers connected in series with each of the coils to enable independent control both amplitude and phase of a flow of current through each coils to generate a magnetic field at each of the arms of each of the cores, wherein in each of the cores a direction of the magnetic field generated at one of the arms is opposite to a direction of the magnetic field generated at each of the other two arms.

13. The device as claimed in claim 12 wherein each of the cores is connected to a three phase alternating current supply.

14. The device as claimed in claim 12 wherein each of the cores is connected to a three phase alternating current supply in three wire Delta configuration.

15. The device as claimed in claim 12 further including a transformer and a fuse electrically connected to each of the switching current controllers to enable the switching current controllers to work synchronously with corresponding lines of a three phase alternating current supply.

16. The electromagnetic induction heating device as claimed in claim 12 wherein each of the arms of a first one of the cores faces a corresponding one of the arms of a second one of the cores, and the coil on each of the arms of the first one of the cores is reverse wound as compared to the coil on the corresponding one of the arms of the second one of the cores.

17. Use of the device as claimed in claim 12 in an application selected from the group of applications including die preheating, mold preheating, bearing heating, extrusion, bending, forging, tempering, curing, stress relieving and demagnetization.

18. An electromagnetic induction heating device for heating a workpiece, the device comprising:
a pair of spaced apart E-shaped cores formed from a plurality of laminated metal sheets, each of the cores having three arms and a coil wound about each of the arms;
a workspace defined in a space between the cores, the workspace being for receiving the workpiece to be heated; and
a plurality of switching current controllers connected in series with each of the coils to enable independent control both amplitude and phase of a flow of current through each coils to generate a magnetic field at each of the arms of each of the cores, wherein each of the arms of a first one of the cores faces a corresponding one of the arms of a second one of the cores, and the coil on each of the arms of the first one of the cores is reverse wound as compared to the coil on the corresponding one of the arms of the second one of the cores.
